(19) United States
(12) Patent Application Publication
(10) Pub. No.: US 2005/0192852 A1
(43) Pub. Date: Sep. 1, 2005

(54) Method for promoting individual fitness

(76) Inventor: Vicki L. Sorensen, Carver, MN (US)

Correspondence Address: STITES & HARBISON PLLC, 1199 NORTH FAIRFAX STREET, SUITE 900, ALEXANDRIA, VA, 22314, US

(21) Appl. No.: 10/785,965

(22) Filed: Feb. 26, 2004

(51) Int. Cl. G06F 17/60

(52) U.S. Cl. 705/7

(57) ABSTRACT

A method for promoting individual fitness includes the initiating a competition that one participant will exercise more than the other. This initiating step includes the steps of designating a time period during which credits will be earned for a qualifying exercise, and designating a total number of time periods to constitute a competition end. During each time period: a first quantity of credits is awarded for each qualifying exercise which each participant performs for a pre-selected number thereof; and a second quantity of credits greater than the first quantity is awarded for a qualifying exercise which each participant performs for a next qualifying exercise after the pre-selected number. During the competition, the credits awarded to each participant are kept track of, so that at the end the sum thereof determines an earned total of credits for each participant which sums are then used to determine an outcome of the competition.

### BACKGROUND OF THE INVENTION

In spite of the well-known benefit of regular physical exercise, and despite the intentions of many people to perform regular physical exercise, it is well documented that too few people do exercise with the desired regularity and intensity. Various aids have been developed to help people to exercise, such as tracking systems, group exercises at set times and even personal assistants. However, regular physical exercise is still difficult to achieve and maintain for many people.

### BRIEF SUMMARY OF THE INVENTION

In accordance with the present invention, a method for promoting individual fitness is provided which will help the participants to achieve regular physical exercise. This method includes the initial step of initiating a competition between two participants, that one participant will have exercised more than the other participant at an end of the competition. This competition initiating step includes the specific steps of (a) designating a time period (e.g., week) during which credits or points will be earned for a qualifying exercise of each participant, and (b) designating a total number of time periods (e.g. eight weeks) to constitute the end of the competition. When the competition is then carried out, (a) a first quantity of credits (e.g., one) is awarded, during each time period, to each participant for each qualifying exercise which each participant performs for a pre-selected number (e.g., first and second) of the qualifying exercises, and (b) a second quantity of credits (e.g., three) greater than the first quantity of credits is awarded, during each time period, to each participant for a qualifying exercise which each participant performs for a next (e.g., third) qualifying exercise after the pre-selected number (two) of qualifying exercises. The method then further includes, during the competition, keeping track of the credits awarded to each participant for each qualifying exercise, so that at the end of the competition the sum of the credits awarded to each participant during the total number of time periods determines an earned total of credits for each participant. The earned totals for each participant is then used to determine an outcome of the competition, which may be a winner, who is then rewarded with a pre-determined prize (preferably a collection or book of discrete prizes).

In a preferred embodiment of the method, a third quantity of credits (e.g., one) is awarded, during each time period, to each participant for each qualifying exercise which each participant performs after the next (third) qualifying exercise. Preferably, the first and third quantity of credits are equal, and the second quantity of credits is three times that of the first quantity of credits.

In the preferred embodiment of this method, the determining of the outcome includes the steps of designating a base number of credits, where
the base number of credits={[(the first quantity of credits)×(the pre-selected number of the qualifying exercises)]+(the second quantity of credits)}×(the total number of time periods).
Then, it is determined whether the two participants were each awarded earned totals which are equal to or exceed the base number (e.g., {[1×2]+3}×8}=40). If so, it is next determined (i) whether the earned total of one participant exceeds the earned total of the other participant by a first predetermined winning quantity (e.g., eight) such that the outcome of the competition is that the one participant is a winner or (ii) whether the earned total of one participant does not exceed the earned total of the other participant by the first predetermined winning quantity such that the outcome of the competition is that neither participant is a winner (though by exercising during the competition, each participant has benefited and thus been rewarded to that extent).

Also in the preferred embodiment, (i) where it is determined that one of the two participants was awarded an earned total which is less than the base number while the other of the two participants was awarded an earned total which is equal to or greater than the base number, then the other participant is determined to be a winner; and (ii) where it is determined that both participants had less than the base number, then neither is a winner. As an alternative embodiment to the above preferred embodiment, where it is determined that one (or both) of the two participants was awarded an earned total which is less than the base number, it is next determined (i) whether the earned total of one participant exceeds the earned total of the other participant by a second predetermined winning quantity (e.g., three) less than the first predetermined winning quantity such that the outcome of the competition is that the one participant is a winner (also called exceeding winner) or (ii) whether the earned total of one participant does not exceed the earned total of the other participant by the second predetermined winning quantity such that the outcome of the competition is that neither participant is a winner (though by exercising during the competition, each participant has benefited and thus been rewarded to that extent).

Also in the preferred embodiment, the initiating step includes the step of choosing a plurality of prizes which can be awarded to the winner at the end of the competition. Then, the rewarding step includes the step of awarding to winner the plurality of prizes. Alternatively, the rewarding step includes the step of selecting, by the winner, one or more of the plurality of prizes. Preferably, at least one of the prizes is an activity to be performed by a non-winning participate. Conveniently, this choosing step includes the step of picking all (or at least some) of the plurality of prizes from a list of suggested prizes.

Further in the preferred embodiment, a list of exercises which qualify for awarding of credits is initially provided or otherwise compiled. Preferably, a duration of time for performing each exercise on the list is also designated in order for the exercise to constitute a qualifying exercise. Also preferably, the designated duration of time is divided into categories for different fitness levels of the participants.

Still further in the preferred embodiment, a recording device is used with which the credits awarded for qualifying exercises are kept track of and displayed. Also, the initiating of the competition step includes execution of a written document by the two participants.

Also in accordance with the present invention, a method for promoting individual fitness is provided which can alternatively be played between a challenger (such as a school) and one or more participants. Participants play the game as broadly indicated above, and they are then rewarded based on the credits earned, as by equaling or exceeding the base number of credits.

It is an object of the present invention to promote individual fitness by engaging participants in a competition which will help to motivate each participant to exercise.

It is also an object of the present invention to motivate each participant to exercise at least a predetermined amount during each predetermined time period.

It is a further object of the present invention to reward one who exercises more and thus becomes a winner of the competition with a prize to further help to motivate each participant to exercise.

It is a still further object of the present invention to designate the prize won by the winner to require some activity by the loser, so that the participants have additional motivation to not be a loser at the end of the competition and hence to perform the desirable exercising.

It is yet another object of the present invention to allow for participants of different fitness levels to compete against one another.

It is still another object of the present invention to motivate the participants to exercise with regularity.

Other features and objects of the present invention are stated in or apparent from detailed descriptions of presently preferred embodiments of the invention found hereinbelow.

### BRIEF DESCRIPTION OF THE SEVERAL VIEWS OF THE DRAWINGS

FIG. 1 is a first embodiment of a tracking calendar in accordance with the method of the present invention.

FIG. 2 is a coupon with a pre-selected prize in accordance with the method of the present invention.

FIG. 3 is a coupon with a prize to be filled in accordance with the method of the present invention.

FIG. 4 is an alternative embodiment of a tracking calendar in accordance with the method of the present invention.

### DETAILED DESCRIPTION OF THE INVENTION

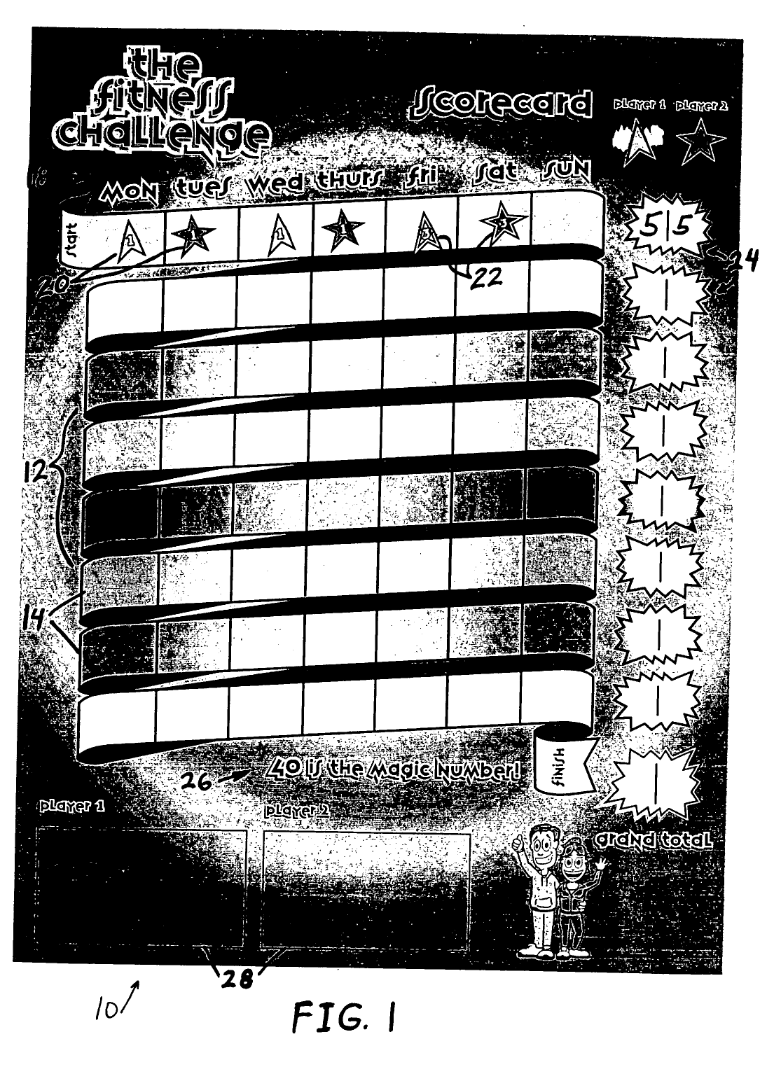

With reference now to the drawings in which like numerals represent like elements, a first preferred embodiment of a method for promoting individual fitness in accordance with the present invention will be described with reference to FIGS. 1-4. While the method of the present invention can be practiced by two (or more) participants who simply agree to the terms and other elements of the method as described herein, it is envisioned for the preferred embodiment that in the terms and other elements will be supplied as a package (such as a box) to be purchased by the participants so that most every aspect of the method is predetermined by the rules and procedures set forth in or on the package—though some selecting of specifics may take place as noted below.

It will initially be appreciated that the present method begins with the initiation of a “friendly” competition between two (or more if desired) participants. The goal of the competition is to have each participant exercise a predetermined amount, and a winner is determined only if one participant has exercised sufficiently more than the other participant at an end of the competition. The competition is created as a way for the participants to make a commitment which will help each of them to be motivated to exercise regularly over the duration of the competition, and hence to help each participant to get fit and stay in shape. As well known, research has shown that thirty minutes of exercise three times a week is a desired goal for getting fit and staying in shape, so that this goal of consistent exercise is what the present method seeks to achieve through the competition.

Thus, the step of initiating the competition includes the step of designating a time period (which is preferably predetermined by the package) during which the competition will be conducted, with credits (or some form of score keeping) being earned for qualifying exercises performed by each participant (which are preferably predetermined by the package). In the preferred embodiment, the time period is a week as this is easy to remember and the goal of exercising three times a week matches this time period. Most preferably, the weekly time period begins on a Monday, so that the weekend is left at the end of each time period. Normally, the weekend provides the days which most people find easiest to perform exercises, so ending each time period at the weekend is expected to afford each participant the easiest schedule with which to perform the needed (as noted below) exercises for that time period as the time period nears completion.

Besides designating a time period, the participants also need to designate a total number of time periods to constitute an end of the competition (which is preferably predetermined by the package). Conveniently, eight time periods of a week each are designated as the total number of time periods, as this number of weekly time periods is sufficient to promote fitness and show results. Obviously, longer or shorter numbers of time periods can be designated by the package or even the participants as desired. The use of eight weekly time periods is also preferably chosen, rather than designating a larger total number of weekly time periods, with the hope that the participants will have seen satisfactory results at the end of the eight weekly time periods and thus then engage in another eight week competition; and hopefully still more competitions to achieve the goal of maintaining and further enhancing the fitness achieved with the first competition.

In order to carry out the competition effectively, some sort of scoring system must be used. With the present method, a unique and motivating scoring system is used. This scoring system (which is preferably predetermined by the package) makes use of the time periods by awarding a first quantity of credits during each time period for the first qualifying (as explained below) exercise, and for each subsequent qualifying exercise up to a preselected number of exercises. Then, a second quantity of credits, greater than the first quantity of credits, is awarded for the next exercise after the preselected number. In the preferred embodiment of the invention, having as noted above the goal of encouraging each participant to exercise three (or more) times a week (the preferred time period), the preselected number is two, the first number of credits is one and the second number of credits is three. Thus, for the first two qualifying exercises performed by a participant in a week, the participant receives two credits; but for the third qualifying exercise, the participant receives three credits. The heavy weighting of the third exercise thus provides an added incentive to reach the desired goal of three exercises a week during each time period.

In the preferred embodiment, qualifying exercises after the next (third) exercise are only rewarded with one credit, the same as the first number of credits, so that there is no big advantage in the competition to doing more than the desired number (three) of exercises during the time period (week), though there is still some advantage in that another credit is achieved. While it is anticipated that every qualifying exercise would be counted, if desired, only one qualifying exercise per day could be counted in order to provide incentive to achieve the three (different) days a week of exercise nominally desired.

As part of the competition, it is necessary to keep track of the quantity of credits earned by each participant. In addition, as an added incentive, it is also desirable for each participant to be able to know how they are doing in earning credits each week and for the number of time periods which have passed. For these reasons, the present invention preferably includes a recording device where the credits awarded are kept track of and preferably displayed (which is preferably provided by the package). In this preferred embodiment, the recording device is a tracking calendar 10 such as depicted in FIG. 1, which can be hung at a suitable location on a refrigerator, bulletin board or the like. Calendar 10 includes a series 12 of eight separate weeks 14 in a vertical orientation, but while this shape is provided for esthetic reasons series 12 could obviously take any desired form of eight separate week in any pattern or orientation. Different colors are also used to highlight the parts of calendar 10 for ease of use and more aesthetic appeal. Preferably, indicia 18 is also provided as a column header for each day of each week 14 identifying the day of the week, and each week 14 begins on a Monday for the reasons as noted above.

Calendar 10 also preferably includes some mechanism for keeping track of performed qualifying exercises by either or preferably by both participants. In this preferred embodiment, the mechanism (which is preferably provided by the package) is stickers 20 and 22 provided in the package or if desired located in area of calendar 10 from which they can be removed and used on calendar 10 as explained below. Stickers 20 are used to identify a qualifying exercise earning the first (one) quantity of credits and thus include a “1” indicia, while stickers 22 are used to identify a qualifying exercise earning the second (three) quantity of credits and thus include a “3” indicia as shown. For easy identification of which participant's sticker is applied, stickers 20 are suitably identified by participant by a color, or in the depicted embodiment (for ease of identification) by an arrow shape and a star shape; while stickers 22 are similarly suitably identified by a different color, (and/)or in the depicted embodiment (for ease of identification) as well by an arrow and a star shape. As appropriate, stickers 20 and 22 of each participant are affixed to a day of a week 14 when the qualifying exercise is performed to provide a visual record of exercises performed, and hence of the need for further exercises that week 14 (time period) if no sticker 22 is yet affixed to that week 14 for the associated participant.

For convenience, an area 24 is provided at the end of each week which is appropriately designated for each participant by the use of their associated shape (in this embodiment) and (or) player “number”. The point total can be then written in area 24 for each designated participant at the end of each week (as shown by each “5” depicted in the top area 24) to readily show a total for that week for each participant. Alternatively, another unique number total sticker (not shown) can be affixed to show that the desired exercises have been performed that week. While participant differentiation is easily provided by colors and/or shapes, other schemes are obviously possible.

In the preferred embodiment, an area 28 is also provided where the prizes to be won are attached. By placing the prizes on calendar 10, each time the participants look at calendar 10 they will see (a part of) their incentive to exercise as well. Having both participants use the same calendar 10 is desirable since it will spur each participant to keep up with or exceed the other, but separate calendars are also possible as it is expected that the two participants will exchange information about their progress in the competition.

If desired, calendar 10 can also include some of the basic rules of the competition as provided by the package, or in the depicted embodiment merely an indication of what the ultimate goal is such as by indicia 26. In addition, to formalize the competition, a separate and formalized document (which is preferably provided by the package and which includes a more extensive version of the rules, etc.) is executed by each participant to formally signify their participation in the competition. If desired, this signed document could include additional information such as discussed hereafter.

As an alternative to aesthetically pleasing calendar 10, the recording device (which is preferably provided by the package) can be seven simple pages showing months with 31 days and not otherwise identified, with each month beginning with the first on different days of the week (to cover all possibilities) or an appropriate usual calendar. Such a recording device could be like most calendars and begin on a Sunday (in which case the participants may choose to begin each time period on a Sunday); or the recording device could be a calendar which begins on a Monday, as shown in FIG. 4 where one (of seven for completeness) calendar 10′ which begins with the first of the month on a Monday is depicted. It will be noted that calendar 10′ shows that both participants are using this recording device; and that both participants have the desired three qualifying exercises that week with each having two (different) stickers 20A and 20B and a sticker 22A and 22B attached thereto, but with one participant having also achieved a fourth exercise that week and thus having an extra sticker 20A′ attached thereto. With either a Sunday or Monday beginning calendar, the participants could then select the suitable pages of the months needed to cover the eight week competition which would thus mirror the actual month(s) of the year—but obviously any extra days of month, where there are not 31 days, would have to be marked off or otherwise ignored. As a different alternative, a computer could instead be used to keep track of the qualifying exercises and competition, as would be readily appreciated by those of ordinary skill in the art.

As part of the incentive to participate in the competition and to win (or at least not to lose) the competition, the present invention preferably includes a plurality of suggested prizes (which are preferably predetermined by the package) from which the participants choose (and complete if necessary) a predetermined number of selected prizes (a “book” of discrete prizes) to be awarded to the winner. Conveniently, the book of prizes is attached to calendar 10 at area 28 as noted above.

Examples of prize(s) which might be chosen as suitable for the winner to select are shown hereafter with a category designation. The category designation is merely for convenience to assist in choosing prizes depending on who you are competing with—friend, spouse child/parent, etc.

PRIZE
HOUSEHOLD CHORES

| | |
|---|---|
| Unload/Load Dishwasher (one week) | Clean (winner's choice) |
| Clean the garage | Organize a Closet |
| | (winner's choice) |
| Weed the Yard | Organize Drawer or Cabinet |
| Clean the basement | (winner's choice) |
| Clean the gutters | Water the Plants |
| Scrub the toilets | Wash my Car |
| Clean a bathroom | Clean the Refrigerator |
| Dust the furniture | Wash the Windows |
| Scrub the floors | Pick up/drop off dry cleaning |
| Trim Hedges | Get the mail for a week |
| Vacuum the House | Clean your office |
| Fix | File your paperwork |
| Mend clothing/sew button | Change the Oil in my Car |
| Shovel the driveway | Run an errand (winner's choice) |
| Paint a room (winner's choice) | Go grocery shopping |
| Mow the lawn | Make Breakfast |
| Rake the leaves | Make Dinner |
| Do the laundry | Make Lunch |
| Take out the trash | Go Pick up the Takeout |

PERSONAL

| | |
|---|---|
| Take out to dinner (winner's choice) | Say for the Day (winner gets to |
| Make Favorite Meal (winner's | choose what both do for the day. |
| choice) | (e.g., sports event, picnic, movie, |
| Subscription to magazine (winner's | golf, museum, visit in-laws, go to |
| choice) | park) |
| Clean my golf clubs | Movie Choice (rental or theater) |
| Wear sexy negligee to bed (winner's | 15 Minute Massage |
| choice) | Get out of Jail Free (winner spends |
| Exclusive rights to garage (term | day any way they want, such as |
| negotiable) | without partner (e.g., go out with |
| Breakfast in bed | the guys or girls) |
| I Choose What's for Dinner | Go shopping |

PETS

| | |
|---|---|
| Feed the Cat | Pooper Scooper the yard |
| Feed the dog | Take the pet to the vet |
| Walk the dog | Groom or bathe the dog |
| Scoop the cat litter | Clean the cat litter box |

PARENTHOOD

| | |
|---|---|
| Chauffer the kids | Put kids to bed |
| Help kids with homework | Read the kids a book |
| Baby-sit for an evening (4 hours) | Do an activity with the kids |
| Change a diaper | Take the kid to the doctor |
| Feed the kids | Feed the baby a bottle |
| Give the kids a bath | Pack the kids lunches |
| Get up with the baby | |

KIDS

| | |
|---|---|
| Video games for one hour | I get to go |
| Internet for one hour | Late bedtime |
| TV for one hour | Activity with me |
| Choice of lunch/dinner | No chores for one week |
| You clean my room | |

In the preferred embodiment, the package directs that prior to starting the competition a plurality of prizes are selected by each participant which comprise the book to be awarded to that participant if that participant is the winner of the competition, Thus, the prize package is not the same for all participants but instead is customized by each participant—though if desired by the participants, the same package could be the book of prizes awarded to either participant declared the winner.

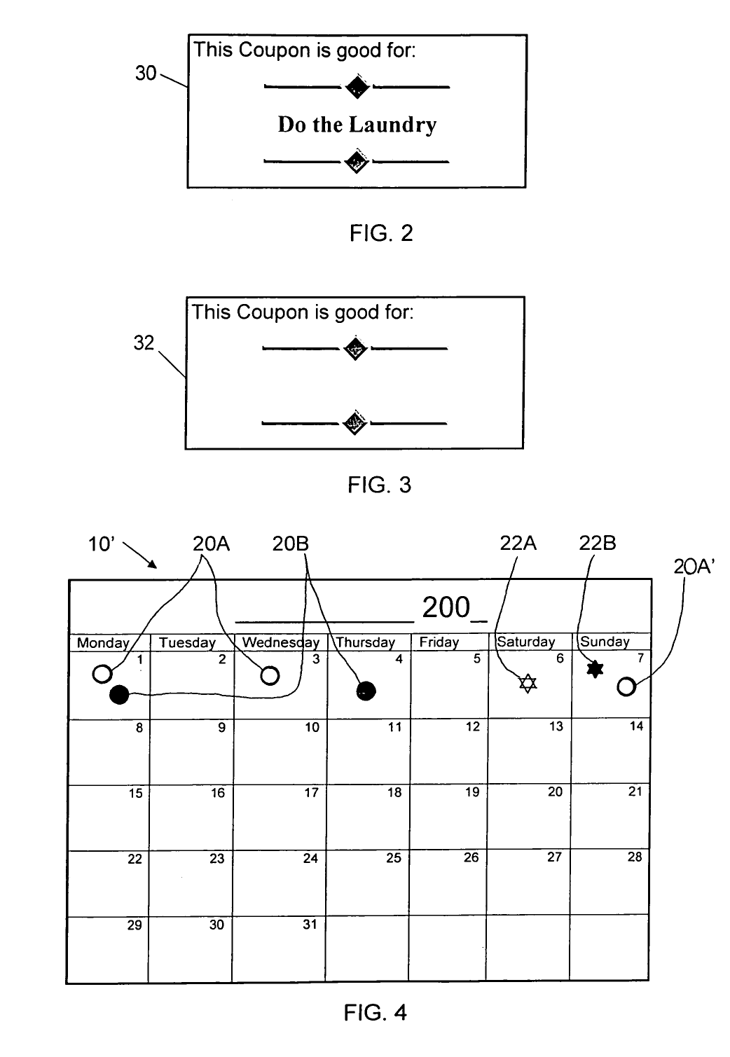

In order to better memorialize the prizes, and to serve as better motivation not to lose, a plurality of coupons 30 or 32 as depicted in FIGS. 2 and 3 are used (which are preferably provided by the package). Coupon 30 is a pre-printed coupon and can be attached to (via paperclip or the like) calendar 10 at area 28 or alternatively to the signed document, etc. Any number of coupons 30 with different prizes can be provided in the package as desired, and the number designated to comprise the book, such as five, is also preferably predetermined by the package. In addition, a plurality of coupons 32 are also preferably provided by the package which the participants can fill in as they desire and agree to. This allows for customization by the participants, both as to what they want to win or want not to lose. The use of coupons also allows them to be easily clipped or otherwise attached to calendar 10 to serve as a visual reminder of what is at stake in the competition, such as at area 28 of calendar 10. Each participant will thus have their own desired prizes, so there is no need in this preferred embodiment for the participants to have to agree on any specific prizes.

It is expected that in most competitions, the participants will each chose a group or book of prizes having a relative weight that is more or less equal (as determined by the participants) and thus which are to be awarded the winner. Obviously some prizes may also be desired by both participants; and if desired, prizes of different weights can be agreed to as added incentive for one participant. In any event, the participants decide between themselves in accordance with the rules (or as customized by the participants) what prizes will be awarded. For example, if desired, the participants can each select one “grand” (as preferably predetermined by the package) prize to be included in their book of prizes—where the grand prize is worth (but not necessarily monetarily) considerably more than the others. Obviously, only a single prize (either grand or not) can be what the winner is awarded if desired.

As noted above, credits will be provided for “qualifying” exercises. In order to determine what a qualifying exercise is, the present invention includes the designating of a listing of exercises (which is preferably provided by the package) before the start of the competition—but which could be modified before or after the start if desired by both participants. Since not all exercises are equal, the listing is preferably broken down into two (or more, if desired) categories depending on the amount of calories expended during the exercise. For the more intense exercises, less time is needed to be a qualifying exercise; while for less intense exercises, more time is required. Examples of exercises which could be listed include the following.

| | |
|---|---|
| More Intense | Less Intense |

GYM ACTIVITIES

| | |
|---|---|
| Aerobics: Step, high impact | Aerobics: low impact |
| Bicycling, Stationery | Aerobics: water |
| Calisthenics: vigorous | Calisthenics: moderate, low |
| Rowing, Stationery | Riders, general (e.g., Health Rider) |
| Ski Machine | Stretching, Hatha Yoga |
| Stair Step Machine | Weight Lifting |

TRAINING AND SPORT ACTIVITIES

| | |
|---|---|
| Basketball: playing a game | Archery: non-hunting |
| Bicycling | Badminton |
| Boxing: sparring | Bowling |
| Dancing: Fast, ballet, twist | Curling |
| Fencing | Dancing: disco, ballroom, square, |
| | slow, waltz, foxtrot |
| Football | Frisbee |
| Handball | Golf |
| Hiking | Gymnastics |
| Hockey | Kayaking |
| Ice Skating | Skateboarding |
| Martial Arts: judo, karate, kickboxing | Skiing: Downhill |
| Race walking | Snorkeling |
| Racquetball | Softball |
| Rock Climbing | Tai chi |
| Rollerblading | Volleyball |
| Rope Jumping | Walking |
| Running/Jogging | Water Volleyball |
| Scuba Diving | Whitewater: rafting, kayaking |
| Skiing: Cross Country | Wrestling |
| Sledding: luge, toboggan | |
| Snow Shoeing | |
| Soccer | |
| Swimming | |
| Tennis | |
| Water Polo | |

If the participants are of equal fitness levels, then the time duration for each category of exercise in order for the exercise to be considered as a qualifying exercise would be equal. However, as often participants will be of different fitness levels, the present invention also provides (preferably as part of the package) for designating a plurality of fitness levels, so that the duration of time needed for a qualifying exercise changes according to the fitness level of the participant doing the exercise. Conveniently, three fitness levels are chosen, such as beginner, intermediate, and advanced. The participants should agree which category applies to each participant prior to the start, but as this should be a friendly competition it is not considered that this should be an issue. For example, the following guidelines and time durations are preferably provided as part of the package.

| | More Intense Exercise | Less Intense Exercise |
|---|---|---|
| | Workout Time Required: | Workout Time Required: |
| Beginner | 20 minutes | 30 minutes |
| Intermediate | 30 minutes | 45 minutes |
| Advanced | 45 minutes | 60 minutes |

Once all of the various determinations needed as discussed above have been agreed to, the competition begins and continues for the agreed upon duration, such as eight weeks. During the competition, calendar 10, 10′, or the like is used to keep track of qualifying exercises performed by one or each participant. At the end of the competition, it is then necessary to sum the number of credits earned by each participant during all of the time periods to determine an earned total of credits. Based on the earned total, a winner can then be determined (if there is a winner as determined by the rules), and once the winner is determined, the winner elects the prize(s) desired as previously agreed to.

While the winner can be determined simply by which participant has the larger earned total of credits, in the preferred embodiment of the “friendly” competition of the present invention the winner (if any) is determined more with the notion that the goal is for both participants to achieve the desired (three times a week) workouts and to improve the fitness level of each participant. As a result of this, there is a chance with the present method that both participants will reach this goal (and be a winner in that sense), but that neither will be declared a winner of the competition. Thus, in accordance with the present invention, the outcome of the competition is determined by initially designating a base number of credits, where:
the base number of credits={[(the first quantity of credits)×(the pre-selected number of the qualifying exercises)]+(the second quantity of credits)}×(the total number of time periods).
Using the preferred numbers noted above (which are preferably designated by the package) as follows:
the first quantity of first quantity of credits=1
the second quantity of first quantity of credits=3
the pre-selected number of the qualifying exercises=2
the total number of time periods=8
   then the base number of credits is [(1×2)+3)]×8=40.

This base number of credits is a reflection of the desired exercise program of three exercises per week. With the use of the second quantity of credits being larger than the first quantity of credits, the base number of credits is thus also heavily weighted towards this desired exercise goal.

Using the base number of credits as weighted above, the winner (if any) of the competition is then determined by first determining if the two participants were each awarded earned totals which are equal to or exceed the base number (40). If so, it is then determined whether the earned total of one participant exceeds the earned total of the other participant by a first predetermined winning quantity (which is preferably designated by the package). If this is the case, then the outcome of the competition is that the one participant is a winner. Preferably, the first predetermined winning quantity is set high, such as eight credits, so that it is difficult for one participant to have that many more credits than the other where both participants achieve or exceed the base number of credits reflecting the goal of exercising three times a week (since the value of the third quantity of credits is the same as the first, or one in the exemplary embodiment). Thus, where both participants achieved the base number, there is no reason, where increasing fitness is the ultimate goal of the competition, to penalize one participant by declaring the other the winner in this situation—except where one participant significantly out-exercises the other. Thus, making the determination in this manner achieves this goal.

In the situation where both participants had earned totals which equaled or exceeded the base number of credits and the earned total of one participant does not exceed the earned total of the other participant by the first predetermined winning quantity (eight in the exemplary embodiment), the outcome of the competition is then that neither participant is a winner and no prizes are awarded. Of course, as noted above, as each participant achieved at least the base number of credits, both participants did achieve the ultimate goal of increasing fitness and to that extent neither participant is a loser. Alternatively, each participant could also be designated a winner for exceeding the base number of credits, with the result that each participant gets one prize each or a preselected prize (such as each taking the other out to lunch).

In the situation where one of the two participants was awarded an earned total which is less than the base number while the other of the two participants was awarded an earned total which is equal to or exceeded the base number, then the other player who exceeded the base number is declared the winner.

In the situation where the earned total of both participants is less than the base number, then neither participant is deemed to be the winner (since neither achieved the goal of exercising three times a week during the eight weeks). However, if desired and as an alternative to the preferred embodiment, where the earned total of both participants is less than the base number it can instead be determined whether the earned total of one participant exceeds the earned total of the other participant by a second predetermined winning quantity which is designated (preferably by the package) to be less than the first predetermined winning quantity. In that case, the outcome of the competition is instead that the one participant with the higher earned total is an “exceeding” winner. This designation serves to show that while the base number was not reached by the exceeding winner, that participant did moderately outperform the other participant and deserves some recognition (such as getting one coupon). In the exemplary embodiment, the second predetermined winning quantity is 3 credits, which only coincidentally happens to be the same as that awarded for the third (in the exemplary embodiment) qualifying exercise of the week. Again, as still another alternative embodiment where neither is a winner, each participant could also be designated a “participating” winner, with the result that each participant gets one prize each of the preselected book of prizes or a preselected prize (such as each taking the other out to lunch).

Further alternatively in the situation where one (or both) of the two participants was awarded an earned total which is less than the base number, a determination is made whether the earned total of one participant exceeds the earned total of the other participant by a second predetermined winning quantity which is designated (preferably by the package) to be less than the first predetermined winning quantity. In that case, the outcome of the competition is that the one participant with the higher earned total is the winner. In the exemplary embodiment, the second predetermined winning quantity is 3 credits, which only coincidentally happens to be the same as that awarded for the third (in the exemplary embodiment) qualifying exercise of the week. Of course, in this embodiment where the earned total of one participant does not exceed the earned total of the other participant by the second predetermined winning quantity, the outcome of the competition is that neither participant is a winner and no prizes are awarded. Again, as an alternative where neither is a winner, each participant could also be designated a winner, with the result that each participant gets one prize each or a preselected prize (such as each taking the other out to lunch).

Where a winner is determined, the winner is then awarded the desired book of prizes (or in some of the alternatives noted above, a prize or prizes from the book). It is then hoped that the participants will initiate another competition, to afford the loser a chance to win over the present winner, but more importantly to motivate both participants to further exercise and hence to increase or maintain their fitness levels.

While the embodiment described above has been described as being between two (or more) participants, it will be appreciated that the present invention can also be adapted to be between a challenger and one or more individuals (again provided as a package). In this case, the challenger can be a person or an organization such as a school or other group. The role of the challenger is to be a motivator and hence to offer the prizes which the participants can win if they earn a predetermined number of credits. Using the preferred embodiment discussed above, the predetermined number of credits would be 40, so that each participant who achieved this number over the eight week competition would be entitled to one or more predetermined prizes offered by the challenger. For a school, the prizes could be extra playtime, a night without homework, etc.; while for an organization, the prizes could be related to the organization, unrelated, or even purchased (free movies rental, etc.).

The method of promoting individual fitness using a challenger would be essentially the same as that between two participants as discussed above, but typically the challenger would determine any variations from the various pre-determined elements designated in the package such as: time period, total number of time periods to constitute the competition, designating the first, second and third quantity of credits, designating what earned total of credits makes a participant a winner, designating the qualifying exercises and durations, choosing the prizes, and designating the fitness levels—though obviously any and all such elements can be negotiated as well if desired (and as appropriate).

While the present invention has been described with respect to exemplary embodiments thereof, various modifications can be effected. For example, rather than—having individual participants, teams of participants can be formed (father/son versus mother/daughter, or other and larger groups, not necessarily equal in number) with suitable changes to the determinations to be made consistent with the goals of the invention and as would be obvious to those skilled in the art.

Thus, while the present invention has been described with respect to exemplary embodiments thereof, it will be understood by those of ordinary skill in the art that variations and modifications can be effected within the scope and spirit of the invention.

1. A method for promoting individual fitness comprising the steps of:
initiating a competition between two participants that one participant will have exercised more than the other participant at an end of the competition, the competition initiating step including the steps of
a) designating a time period during which credits will be earned for a qualifying exercise of each participant,
b) designating a total number of time periods to constitute the end of the competition,
carrying out of the competition by the two participants, said carrying out step including the steps of
a) awarding a first quantity of credits, during each time period, to each participant for each qualifying exercise which each participant performs for a pre-selected number of the qualifying exercises,
b) awarding a second quantity of credits greater than the first quantity of credits, during each time period, to each participant for a qualifying exercise which each participant performs for a next qualifying exercise after the pre-selected number of qualifying exercises, and
c) keeping track of the credits awarded to each participant for each qualifying exercise during the competition;
summing, at the end of the competition, the quantity of credits awarded to each participant during the total number of time periods to determine an earned total of credits for each participant;
determining, by the earned totals for each participant, an outcome of the competition; and
where the outcome of the competition is a winner, rewarding the winner with a pre-determined prize.

2. A method for promoting individual fitness as claimed in claim 1, wherein said carrying out step further includes the step of awarding a third quantity of credits, during each time period, to each participant for each qualifying exercise which each participant performs after the next qualifying exercise.

3. A method for promoting individual fitness as claimed in claim 2, wherein the first and third quantity of credits are equal, and the second quantity of credits is three times that of the first quantity of credits.

4. A method for promoting individual fitness as claimed in claim 1, wherein said determining of the outcome step includes the steps of:
a) designating a base number of credits, where
the base number of credits={[(the first quantity of credits)×(the pre-selected number of the qualifying exercises)]+(the second quantity of credits)}×(the total number of time periods),
b) determining if the two participants Were each awarded earned totals which are equal to or exceed the base number, and if so determining
i) whether the earned total of one participant exceeds the earned total of the other participant by a first predetermined winning quantity such that the outcome of the competition is that the one participant is a winner or
ii) whether the earned total of one participant does not exceed the earned total of the other participant by the first predetermined winning quantity such that the outcome of the competition is that neither participant is a winner; and
c) determining if one of the two participants was awarded an earned total which is less than the base number while the other of the two participants was awarded an earned total which is equal to or greater than the base number, and if so determining that the other participant is a winner.

5. A method for promoting individual fitness as claimed in claim 1, wherein said determining of the outcome step includes the steps of:
a) designating a base number of credits, where
the base number of credits={[(the first quantity of credits)×(the pre-selected number of the qualifying exercises)]+(the second quantity of credits)}×(the total number of time periods),
b) determining if the two participants were each awarded earned totals which are equal to or exceed the base number, and if so determining
i) whether the earned total of one participant exceeds the earned total of the other participant by a first predetermined winning quantity such that the outcome of the competition is that the one participant is a winner or
ii) whether the earned total of one participant does not exceed the earned total of the other participant by the first predetermined winning quantity such that the outcome of the competition is that neither participant is a winner; and
c) determining if one of the two participants was awarded an earned total which is less than the base number, and if so determining
i) whether the earned total of one participant exceeds the earned total of the other participant by a second predetermined winning quantity less than the first predetermined winning quantity such that the outcome of the competition is that the one participant is a winner or
ii) whether the earned total of one participant does not exceed the earned total of the other participant by the second predetermined winning quantity such that the outcome of the competition is that neither participant is a winner.

6. A method for promoting individual fitness as claimed in claim 1:
wherein said initiating step includes the step of choosing a plurality of prizes which can be awarded to the winner atthe end of the competition; and
wherein said rewarding step includes the step of awarding to the winner the plurality of prizes.

7. A method for promoting individual fitness as claimed in claim 6, wherein at least one of said prizes is an activity to be performed by a non-winning participate.

8. A method for promoting individual fitness as claimed in claim 6, wherein said choosing step includes the step of picking the plurality of prizes from a list of suggested prizes.

9. A method for promoting individual fitness as claimed in claim 1, wherein said awarding steps for qualifying exercises includes the steps of:
a) designating a list of exercises which qualify, and
b) designating a duration of time for performing each exercise on the list so that the exercise constitutes a qualifying exercise.

10. A method for promoting individual fitness as claimed in claim 8, wherein the duration of time is divided into categories for different fitness levels of the participants.

11. A method for promoting individual fitness as claimed in claim 1, wherein said carrying out step includes a recording device with which the credits awarded are kept track of and displayed.

12. A method for promoting individual fitness as claimed in claim 1, wherein said initiating a competition step includes execution of a written document by the two participants.

13. A method for promoting individual fitness comprising the steps of:
initiating a competition between two participants that one participant will exercise more than the other participant at an end of the competition, the competition initiating step comprising the steps of
a) designating a time period during which credits will be earned for a qualifying exercise of each participant,
b) designating a total number of time periods to constitute the end of the competition,
c) designating a first quantity of credits to be awarded, during each time period, to each participant for each qualifying exercise which each participant performs for a pre-selected number of the qualifying exercises,
d) designating a second quantity of credits greater than the first quantity of credits to be awarded, during each time period, to each participant for a qualifying exercise which each participant performs for a next qualifying exercise after the pre-selected number of qualifying exercises, and
e) designating a third quantity of credits to be awarded, during each time period, to each participant for each qualifying exercise which each participant performs after the next qualifying exercise;
carrying out of the competition by the two participants, said carrying out step including the step of keeping track of the credits awarded to each participant for each qualifying exercise during the competition, and
summing, at the end of the competition, the quantity of credits awarded to each participant during the total number of time periods to determine an earned total of credits for each participant;
determining, by the earned totals for each participant, an outcome of the competition, said determining of the outcome step includes the steps of
a) designating a base number of credits, where
the base number of credits={[(the first quantity of credits)×(the pre-selected number of the qualifying exercises)]+(the second quantity of credits)}×(the total number of time periods),
b) determining if the two participants were each awarded earned totals which are equal to or exceed the base number, and if so determining
i) whether the earned total of one participant exceeds the earned total of the other participant by a first predetermined winning quantity such that the outcome of the competition is that the one participant is a winner or
ii) whether the earned total of one participant does not exceed the earned total of the other participant by the first predetermined winning quantity such that the outcome of the competition is that neither participant is a winner;
c) determining if the two participants were each awarded earned totals which are less than the base number, and if so determining that neither participant is a winner; and
d) determining if one of the two participants was awarded an earned total which is less than the base number while the other of the two participants was awarded an earned total which is equal to or greater than the base number, and if so determining that the other participant is a winner; and
where the outcome of the competition is a winner, rewarding the winner with a predetermined prize.

14. A method for promoting individual fitness as claimed in claim 13, wherein the first and third quantity of credits are equal, and the second quantity of credits is three times that of the first quantity of credits.

15. A method for promoting individual fitness as claimed in claim 13:
wherein said initiating step includes the step of choosing a plurality of prizes which can be awarded to the winner at the end of the competition; and
wherein said rewarding step includes the step of awarding to the winner the plurality of prizes.

16. A method for promoting individual fitness as claimed in claim 15, wherein at least one of said prizes is an activity to be performed by a non-winning participate.

17. A method for promoting individual fitness as claimed in claim 15, wherein said choosing step includes the step of picking the plurality of prizes from a list of suggested prizes.

18. A method for promoting individual fitness as claimed in claim 13, wherein said awarding steps for qualifying exercises includes the steps of:
a) designating a list of exercises which qualify, and
b) designating a duration of time for performing each exercise on the list so that the exercise constitutes a qualifying exercise.

19. A method for promoting individual fitness as claimed in claim 18, wherein the duration of time is divided into categories for different fitness levels of the participants.

20. A method for promoting individual fitness as claimed in claim 19, wherein said carrying out step includes a recording device with which the credits awarded are kept track of and displayed.

21. A method for promoting individual fitness as claimed in claim 20, wherein said initiating a competition step includes execution of a written document by the two participants.

22. A method for promoting individual fitness as claimed in claim 13, wherein said determining if the two participants were each awarded earned totals which are less than the base number step further includes the step of determining whether the earned total of one participant exceeds the earned total of the other participant by a second predetermined winning quantity less than the first predetermined winning quantity, and if so determining that the outcome of the competition is that the one participant is an exceeding winner entitled to the same benefits as a winner.

23. A method for promoting individual fitness comprising the steps of:
initiating a competition between a challenger and each participant that each participant will have exercised more than a preselected amount at an end of the competition, the competition initiating step comprising the steps of
(a) designating a time period during which credits will be earned for a qualifying exercise of each participant,
(b) designating a total number of time periods to constitute an end of the competition,
(c) designating a first quantity of credits for each qualifying exercise which each participant performs, during each time period, for a pre-selected number of qualifying exercises, and
(d) designating a second quantity of credits greater than the first quantity of credits for each qualifying exercise which each participant performs, during each time period, for a next qualifying exercise performed after the pre-selected number of qualifying exercises;
keeping track of the credits awarded to each participant during each time period;
summing, at the end of the competition, the quantity of credits awarded to each participant during the total number of time periods to determine an earned total of credits for each participant;
determining, by the earned totals for each participant, whether each participant is a winner of the competition; and
rewarding each winner of the competition with a pre-determined prize.

24. A method for promoting individual fitness as claimed in claim 23, wherein said initiating step further includes the step of designating a third quantity of credits for each qualifying exercise which each participant performs, during each time period, after the next qualifying exercise.

25. A method for promoting individual fitness as claimed in claim 24, wherein the first and third quantity of credits are equal, and the second quantity of credits is three times that of the first quantity of credits.

26. A method for promoting individual fitness as claimed in claim 23, wherein said determining of the outcome step includes the steps of:
a) designating a base number of credits, where
the base number of credits={[(the first quantity of credits)×(the pre-selected number of the qualifying exercises)]+(the second quantity of credits)}×(the total number of time periods),
b) determining if each participant was awarded earned totals which are equal to or exceed the base number, making that participant a winner;

27. A method for promoting individual fitness as claimed in claim 23:
wherein said initiating step includes the step of choosing a plurality of prizes which can be awarded to each winner at the end of the competition; and
wherein said rewarding step includes the step of selecting, by each winner, of one or more of the plurality of prizes.

28. A method for promoting individual fitness as claimed in claim 23, wherein said initiating step further includes the steps of:
a) designating a list of exercises which qualify, and
b) designating a duration of time for performing each exercise on the list so that the exercise constitutes a qualifying exercise.

29. A method for promoting individual fitness as claimed in claim 28, wherein the duration of time is divided into categories to match a fitness level of each participant.

30. A method for promoting individual fitness as claimed in claim 23, wherein said carrying out step includes a recording device with which the credits awarded to each participant are kept track of and displayed.

31. A method for promoting individual fitness as claimed in claim 23, wherein said initiating a competition step includes execution of a written document by each participant.
